(19) United States
(12) Patent Application Publication
(10) Pub. No.: US 2012/0016988 A1
(43) Pub. Date: Jan. 19, 2012

(54) SUPERVISION OF LI AND DR QUERY ACTIVITIES

(75) Inventors: Amedeo Imbimbo, Caivano (IT); Giuseppe Carnevale, Napoli (IT)

(73) Assignee: Telefonaktiebolaget L M Ericsson (pulb), Stockholm (SD)

(21) Appl. No.: 13/259,470

(22) PCT Filed: Apr. 22, 2009
(86) PCT No.: PCT/SE2009/050415

§ 371 Date: Sep. 27, 2011

(51) Int. Cl. G06F 11/30

(52) U.S. Cl. 709/224

(57) ABSTRACT

The present invention relates to a method for supervising log activities in a Communication Service Provider's domain (CSP) comprising a monitoring system (DR, LI) and a Log System. The method comprises steps of sending a request for log activities and receiving a result via standard defined interfaces (HIXA, HIXB, HIA, HIB; HIX1, HIX2, HI1, HI2) between a public authority (RA, LEMF) and the Provider's domain (CSP).

### TECHNICAL FIELD

The present invention relates to methods and arrangements for supervising query activities in a monitoring system.

### BACKGROUND

In many countries the operators and Internet service providers are today obliged by legal requirements to provide stored traffic data generated from public telecommunication and Internet services for the purpose of detection, investigation and prosecution of crime and criminal offences including terrorism. FIG. 1 belongs to the prior art and shows the Handover Interfaces between a Data Retention DR System (see e.g. ETSI TS 102 657 and ETSI DTS/LI-0039) in a Communication Service Provider's CSP domain, and a Requesting Authority RA. The figure shows an Administration Function AdmF used to handle and forward requests from/to the RA. A Mediation and Delivery function MF/DF is used to mediate and deliver requested information. A Data Collection Function DCF is used to collect and retain all possible data from the Network or IT systems NW/IT within the CSP domain. The generic Handover Interface adopts a two port structure such that administrative request/response information and Retained Data Information are logically separated. The Handover Interface port 1 HIA transports various kinds of administrative, request and response information from/to the Requesting Authority and the organization at the CSP which is responsible for Retained Data matters. The Handover Interface port 2 HIB transports the retained data information from the CSP, to the Requesting Authority.

FIG. 1 discloses the already mentioned Communication Service Provider's domain comprising a Data Retention DR System and a Log System. It is required that every interrogation, also called query, of the Data Retention System that is performed by the Requesting Authority via the Handover Interface HIA shall be logged in the Log System (see also e.g. FIG. 2 in ETSI TR 102 661 v1.1.1). The result of the interrogation may also be required to be logged. Users with special roles are authorized to query the interrogation logs, and may be assigned to one, more or all Law Enforcement Agencies LEAs. The purpose for the user with special roles is to prevent abuse such as accidental or unlawful destruction, accidental loss or alteration, or unauthorized or unlawful storage, processing, access or disclosure. In FIG. 1 the user is represented by a laptop associated to the Log System via an operator OP.

While data from the past is used when Data Retention is practiced, Lawful Interception is a real-time exercise. FIG. 2 is part of the prior art and discloses a Lawful Interception LI System. The LI System is a solution for monitoring of Interception Related Information IRI and Content of Communication CC for a target. The different parts used for interception are disclosed in current Lawful Interception standards (see 3GPP TS 33.108 and 3GPP TS 33.107—Release 7). A Law Enforcement Monitoring Facility LEMF is connected to three Mediation Functions MF, MF2 and MF3 respectively for ADMF, DF2, DF3 i.e. an Administration Function ADMF and two Delivery Functions DF2 and DF3. The Administration Function and the Delivery Functions are each one connected to the LEMF via standardized handover interfaces HI1-HI3, and connected via interfaces X1-X3 to an Intercepting Control Element ICE in a telecommunication system. Together with the delivery functions, the ADMF is used to hide from ICEs that there might be multiple activations by different Law Enforcement Agencies. A message REQ sent from LEMF to ADMF via HI1 and from the ADMF to the network via the X1_1 interface comprises a warrant to receive identities of a target that is to be monitored. The Delivery Function DF2 receives Intercept Related Information IRI from the network via the X2 interface. DF2 is used to distribute the IRI to relevant Law Enforcement Agencies via the HI2 interface. The Delivery Function DF3 receives Content of Communication CC, i.e. speech and data, on X3 from the ICE. Requests are also sent from the ADMF to the Mediation Function MF2 in the DF2 on an interface X1_2 and to the Mediation Function MF3 in the DF3 on an interface X1_3. The requests sent on X1_3 are used for activation of Content of Communication, and to specify detailed handling options for intercepted CC.

FIG. 2 discloses a Communication Service Provider's CSP's domain comprising a Lawful Interception LI System and a Log System. Like in the Data Retention case also when it comes to Lawful Interception, it is required that activities by a requesting authority, in this case via the Handover Interface HI1, shall be logged in a Log System (see e.g. FIG. 1 in ETSI TR 102 661 v1.1.1). In the lawful interception solution, it is required that all target administration commands (setting, removal, change, view) sent via HI1 is logged in the Log System in a warrant administration command log. Users with special roles will be authorized to query the warrant administration command log. The purpose for the user with special roles in the LI case might be to prevent abuse such as illegal snooping for private or commercial aims. In FIG. 2 the user is represented by a laptop associated to the Log System via an operator OP.

Problems and drawbacks with the prior art are the necessity for the user with special roles to be associated to the Log System via an operator. This forces the user with special roles (e.g. a judge) to supervise the log activities only after having asked a service/telecom operator to provide such logs. This in turn restricts the judge's privileges.

### SUMMARY

An aim of the present invention is to overcome the above problems and drawbacks affecting the prior art. Within this aim, an object of the present invention is to improve the privileges for a user with special roles when supervising log activities created by investigators.

The invention focuses on improving privileges for an authority to supervise investigators and by that simplify prevent of abuse.

The problem is solved by the invention by introducing a protocol mechanism to supervise, via standard defined interfaces, log activities in a Communication Service Provider's CSP's domain.

More in detail, the invention comprises a method for supervising log activities in the Communication Service Provider's CSP's domain. The method comprises steps of sending requests for log activities and receiving results via standard defined interfaces between the CSP domain a public authority.

According to a first exemplary embodiment, the Communication Service Provider's CSP's domain comprises a Data Retention system and a Log system. The interface in use constitutes an interface between a Requesting Authority and the Log system, or alternatively the interface constitutes an interface between the Requesting Authority and the Data Retention system.

According to a second exemplary embodiment, the Communication Service Provider's CSP domain comprises a Lawful Interception system and a Log system. The interface in use constitutes an interface between a Law Enforcement Management Function and the Log system, or alternatively the interface constitutes an interface between the Law Enforcement Management Function and the Lawful Interception system.

Parameters according to the invention to be used in the protocols sent via the interfaces both in the DR and LI configuration have been exemplified.

An object of the invention is to simplify supervision of activities performed by investigators. This object and others are achieved by methods, arrangements, nodes, systems and articles of manufacture.

The invention results in advantages such as it facilitates supervision of investigators via standard defined interfaces without intervention by an operator. Abuse performed by an Investigator can hereby in a simplified way be detected.

The invention will now be described more in detail with the aid of preferred embodiments in connection with the enclosed drawings.

### BRIEF DESCRIPTION OF THE DRAWINGS

FIG. 1 is part of the prior art and discloses a block schematic illustration of a Communication Service Provider's domain comprising a Data Retention System and a Log System. A Laptop is attached to the Log System for querying purposes.

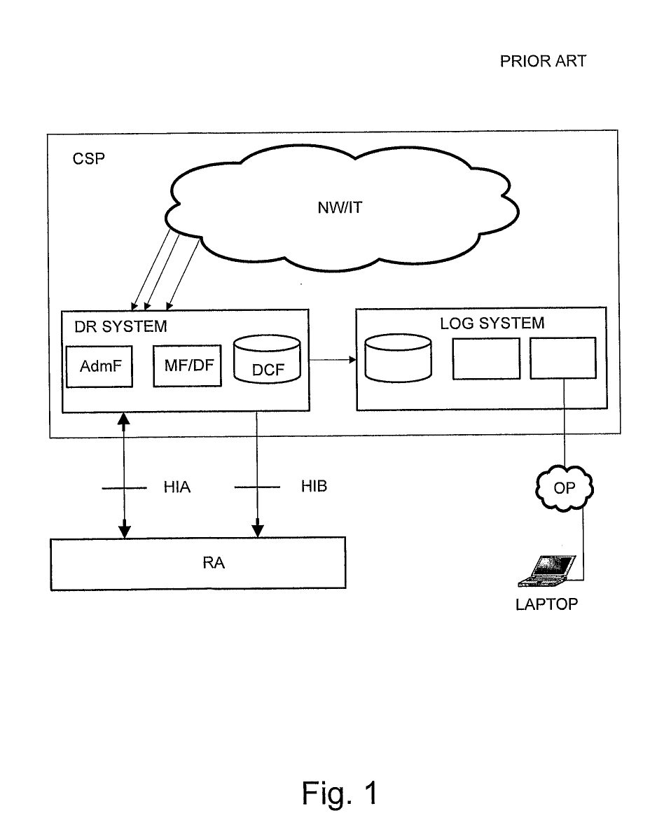

FIG. 2 is part of the prior art and discloses a block schematic illustration of a Communication Service Provider's domain comprising a Lawful Interception System and a Log System. A Laptop is attached to the Log System for quering purposes.

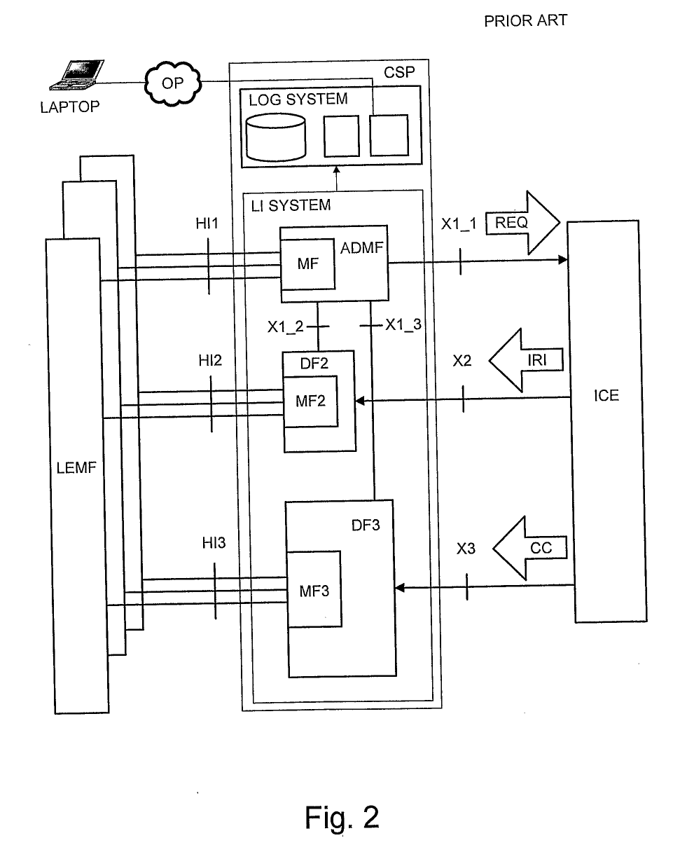

FIG. 3 is a block schematic illustration of the configuration shown in FIG. 1 but with supplementary interfaces between the Log System and a Public (Requesting) Authority.

FIG. 4 discloses a signal sequence diagram representing supervision of log activities performed by an investigator in a Data Retention system.

FIG. 5 is a block schematic illustration of the configuration shown in FIG. 2 but with supplementary interfaces between the Log System and a Public Authority (Law Enforcement Management Function).

FIG. 6 discloses a signal sequence diagram representing supervision of log activities performed by an investigator in a Lawful Interception system.

### DETAILED DESCRIPTION

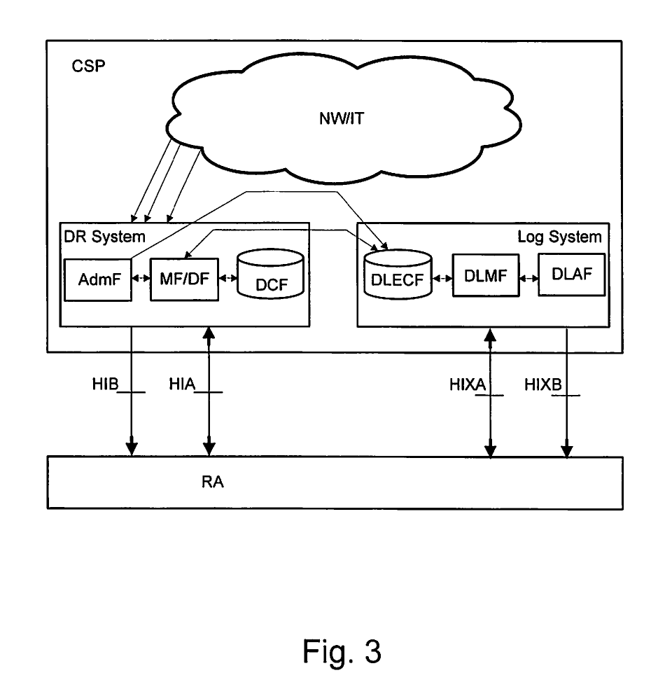

FIG. 3 discloses in a first embodiment a Data Retention configuration. FIG. 3 shows a Communication Service Provider's CSP domain that comprises a Data Retention DR System and a Log System. Handover Interfaces HIA and HIB can be seen between the Data Retention DR System and a Requesting Authority RA, also called Public Authority. The configuration in FIG. 3 includes the AdmF, MF/DF, DCF, HIA, HIB and RA that have been explained earlier in the background part of this application. The earlier mentioned Network or IT systems NW/IT within the CSP domain is in this embodiment acting as data retention source. The transportation of data from NW/IT to the MF/DF is schematically shown in the figure with three arrows from NW/IT to the DR System. Data records fulfilling configured filtering criteria are mediated from MF/DF to the Data Collection Function DCF. Updating of the DCF depends on the policy regulating the notifications with the user, session or operator related data, from the data retention sources towards the DCF. Accordingly, the transportation of the data from the sources to the storage via the MF/DF is handled by an automatic Data Retention DR system. The Data Retention system is part of the prior art and the transportation of data is a pre-requisite for this invention. The Log System disclosed in FIG. 3 comprises a Log Event Collection Function DLECF that is a data base in which log activities i.e. interrogations (also called queries) from the Public Authority are collected, from MF/DF in the DR System. To be noted is that also queries that have been blocked by the administrative function itself, without being notified to the MF/DF, may be collected, from AdmF in the DR System. Collections from MF/DF and Admf to DLECF have been shown in the figure with arrows between the entities. A Log Administration Function DLAF is capable to receive requests for collected log events for example from an external supervisor. A Log Management. Function DLMF mediates requests and log events between the DLAF and DLECF. According to the invention, Handover Interfaces HIXA and HIXB can be seen between the Log System and the Requesting Authority RA. The usage of these interfaces will be further explained later in the description when the invention is discussed.

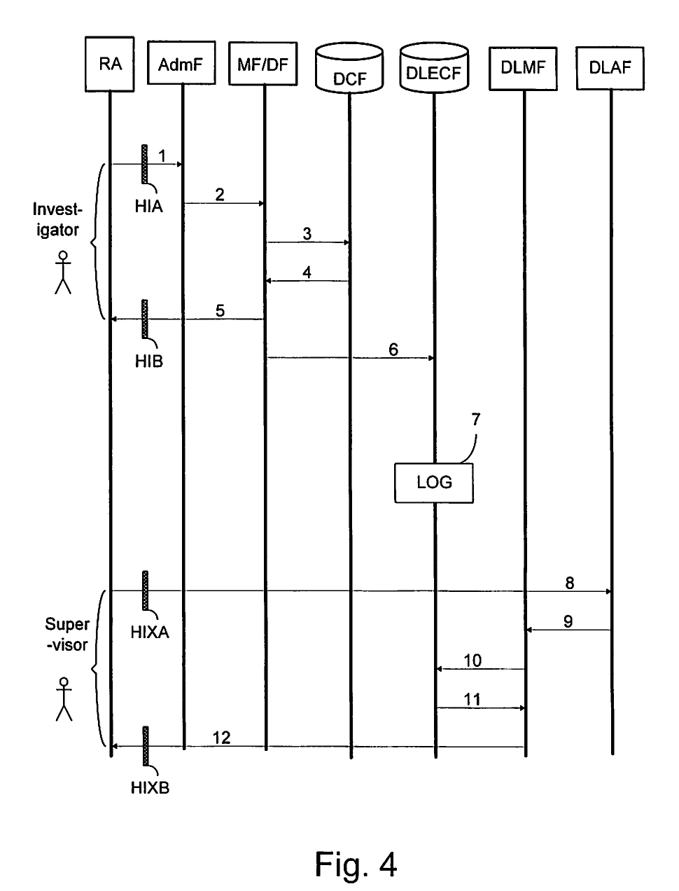

FIG. 4 discloses a signal sequence diagram representing supervision of interrogations that have been performed by the Investigator. The figure discloses the entities HIA, HIB, HIXA, HIXB, RA, AdmF, MF/DF, DCF, DLECF, DLMF and DLAF that have been discussed earlier. The figure also shows a user acting as Investigator and a user acting as Supervisor, both acting via the Requesting Authority RA. The first embodiment of the invention will now be explained together with FIG. 4. The method is divided into two different parts related to the Investigator and the Supervisor.

The method in the first exemplified embodiment comprises the following steps:

### PART I: THE INVESTIGATOR

A monitoring request regarding internet and telecommunication data like for example identities like MSISDN, IMSI, e-mail address is determined by the Investigator at the Requesting Authority RA and sent 1 to the AdmF via the interface HIA.
The AdmF informs 2 the Mediation and Delivery function MF/DF of the request.
The requested data is required 3 by the Mediation and Delivery function MF/DF and the data (identities in this example) is found and fetched 4 from DCF.
The received data is sent 5 as Message Data Records from the MF/DF on the interface HIB, to the RA.
It is required that every interrogation via the Handover interface HIA shall be logged in the Log System, including the interrogation parameters, the interrogating user, the time of interrogation and all other available information on the interrogation. The result of the interrogation sent via HIB may also be required to be logged. Information related to the interrogation is sent 6 from the MF/DF in the DR System to the DLECF in the Log System via an interface between the DR System and the log System, in a manner that is obvious to someone skilled in the art.
The activity i.e. the query from the Investigator is logged LOG 7 in the Log Event Collection Function DLECF.

### PART 2: THE SUPERVISOR

According to the invention, a request regarding performed queries from investigators to the Data Retention System is sent 8 from the Supervisor to the Log Administration Function DLAF via the interface HIXA. Unlike in the prior art case when a private interface was used for the request, now instead the standard defined interface HIXA is used and by that the supervisor can act without having to ask a service/telecom operator to provide requested queries.
The DLAF informs 9 the Log Management Function DLMF of the request from the Supervisor.
The requested data regarding queries are required 10 by the DLMF and the data (the query from the Investigator and optionally the result of the query) is found and fetched 11 from the Log Event Collection Function DLECF.
The requested data regarding queries is forwarded 12 as Message Data Records from the DLMF on the standard defined interface HIXB, to the Supervisor.

The elements included in the request from the Supervisor contain the parameters for querying the system to obtain details about queries/log activities that have been previously executed. The request can be specified to a certain time frame, and to specific values of the elements in the original request. All the provided parameters are handled in an “AND” relationship (or optionally in any other type of Boolean expression relationOip), so they can be used to further restrict the domain of the data on which the query is performed. Below can be found examples of requests sent from the Supervisor.
timeWindow
The time window in which the query has been performed.
user
The user that performed the query.
countryCode
The country code specified in the query.
authorisedOrganisationID
The ID of the Authorized Organization specified in the query.
requestNumber
The query reference identifier specified in the query.
cSPID
The CSP identifier specified in the query.
thirdPartyCSPID
The third party CSP identifier specified in the query.
Target identities
Identities provided in the interrogation.

An acknowledgement of the request contains the response to a request performed on the log of the system. It can either be a positive one, in which case a query element will be reported, or an error in which case an error element is included. Examples of acknowledgements can be found below.
query
This sequence lists all the queries that match the specified request. If no match is found nothing will be reported but no error is raised.
error
This element is used to report error resulting from the execution on the query of the logs.

Instead of using the interfaces HIXA and HIXB, as an alternative the interfaces HIA and HIB can be used. In this case HIA will communicate with AdmF (instead of HIXA communicating with DLAF) and HIB will communicate with MF/DF (instead of HIXB communicating with DLMF), and the requested logged activity will be fetched from DLECF via an interface between the DR and log Systems. This will all be done in a manner obvious to someone skilled in the art.

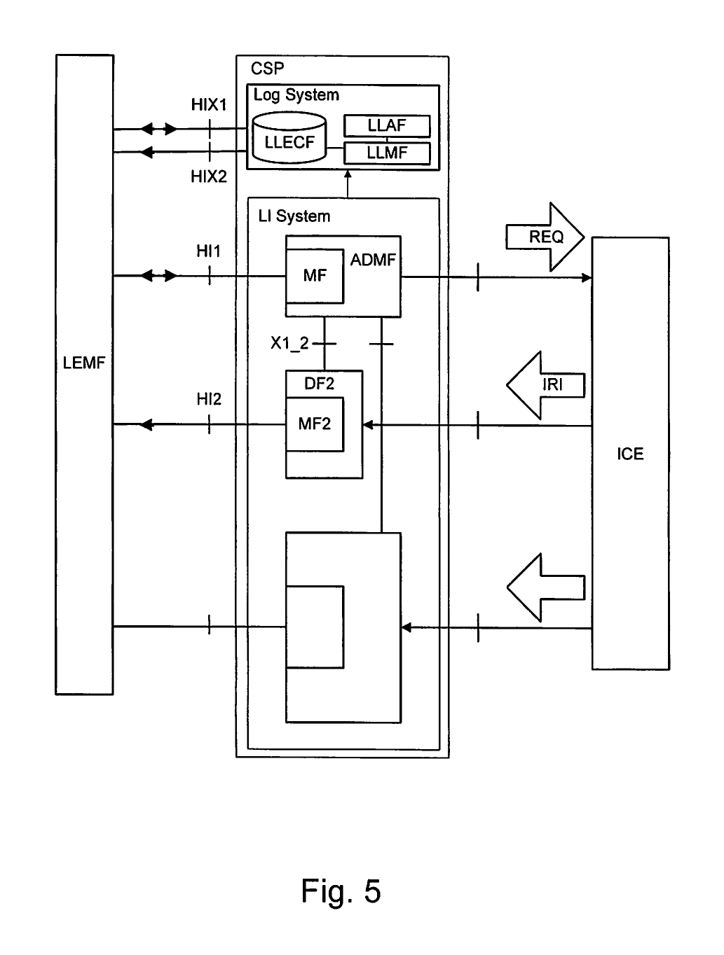

FIG. 5 discloses in a second embodiment, a Lawful Interception configuration. FIG. 5 shows a Communication Service Provider's CSP domain that comprises a Lawful Interception LI System and a Log System. Handover Interfaces HI1 and HI2 can be seen between the Lawful Interception LI System and a Law Enforcement Management Function LEMF, also called Public Authority. The configuration in FIG. 5 includes the ADMF, MF, MF/DF2, ICE, HI1, HI2 and LEMF that have been explained earlier in the background part of this application. The Log System disclosed in FIG. 5 comprises a Log Event Collection Function LLECF that is a data base in which log events i.e. warrants from the Public Authority are collected. In the lawful interception solution, it is required that all target administration commands (setting, removal, change, view) sent via HI1 is logged in the Log System in a warrant administration command log, i.e in the LLECF. The collecting of a log has been shown in FIG. 5 with an arrow between the LI and Log Systems. A Log Administration Function LLAF is capable to receive requests for collected log events for example from an external supervisor. A Log Management Function LLMF mediates requests and log events between the LLAF and LLECF. According to the invention Handover Interfaces HIX1 and HIX2 can be seen between the Log System and the LEMF. The usage of these interfaces will be further explained later in the description when the invention is discussed.

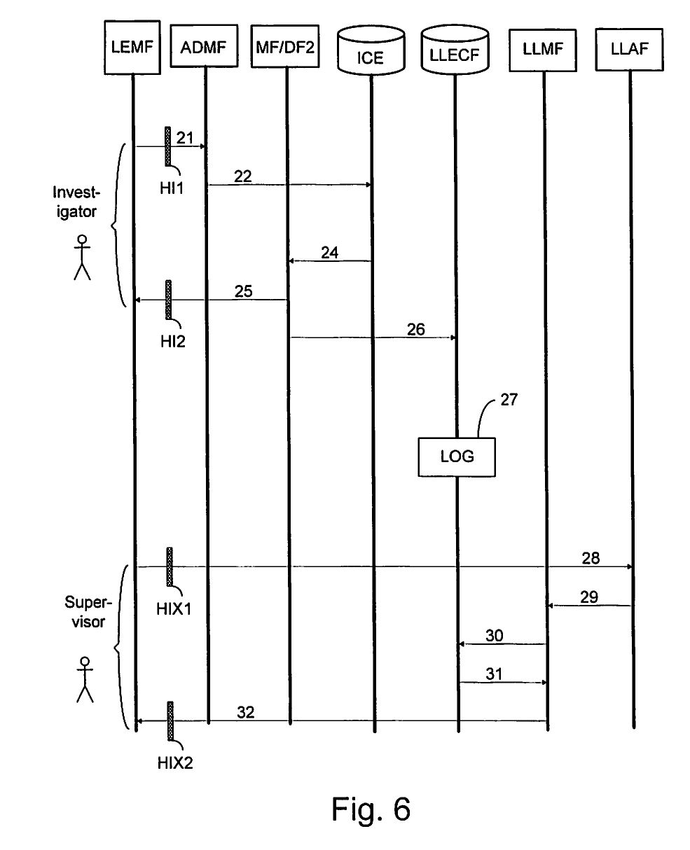

FIG. 6 discloses a signal sequence diagram representing supervision of warrant commands that have been performed by the Investigator. The figure discloses the entities HI1, HI2, HIX1, HIX2, LEMF, ADMF, MF/DF2, ICE, LLECF, LLMF and LLAF that have been discussed earlier. The figure also shows a user acting as Investigator and a user acting as Supervisor via the LEMF. The second embodiment of the invention will now be explained together with FIG. 6. The method is divided into two different parts related to the Investigator and the Supervisor.

The method in the second exemplified embodiment comprises the following steps:

### PART 1: THE INVESTIGATOR

A monitoring request comprising a warrant related to Intercept Related Information IRI from a target is sent 21 from the Investigator at the LEMF to the ADMF via the interface HI1.
The ADMF informs 22 via a Mediation function MF (not shown in FIG. 6) the ICE of the request.
The IRI related to the target is found and fetched 24 from ICE to the Mediation and Delivery function MF/DF2.
The received IRI is sent 25 from the MF/DF2 on the interface HI2, to the LEMF.
It is required that every warrant via the Handover Interface HI1 shall be logged in the Log System. The result of the warrant request (IRI in this case) may also be required to be logged, and information related to the warrant is sent 26 from the MF/DF2 in the LI System to the LLECF in the Log System.
The query from the Investigator is logged LOG 27 in the Log Event Collection Function LLECF.

### PART 3: THE SUPERVISOR

According to the invention, a request regarding performed activities from investigators, which activities concern commands to set target of interception i.e. warrants, is sent 28 from the Supervisor to the Log Administration Function LLAF via the interface HIX1. Unlike in the prior art case when a private interface was used for the request, now instead the standard defined interface HIX1 is used and by that the supervisor can act without having to ask a service/telecom operator to provide requested activities.
The LLAF informs 29 the Log Management Function LLMF of the request from the Supervisor.
The requested data regarding activities are required 30 by the LLMF and the data (the warrant from the Investigator and optionally the IRI) is found and fetched 31 from the Log Event Collection Function LLECF.
The requested data is forwarded 32 from the LLMF on the interface HIX2, to the Supervisor.

The elements included in the request from the Supervisor contain the parameters for querying the system, to obtain details about activities from Investigators on warrant commands that have been previously given to LI System. The request can be specified to a certain time frame. All the provided parameters are handled in an “AND” relationship (or optionally in any other type of Boolean expression relationship), so they can be used to further restrict the domain of the data on which the query is performed.
timeWindow
The time window in which the warrant command has been ordered.
user
The user that ordered the warrant command.
Target identities
Identities of the target of interception
Interception options
Interception options (e.g. content of communication interception required or not).

An acknowledgement of the request contains the response to a request performed on the log of the system. It can either be a positive one, in which case a query element will be reported, or an error in which case an error element is included. Examples of acknowledgements can be found below.
Warrant
This sequence lists all the warrant command details that match the specified request. If no match is found nothing will be reported but no error is raised. Warrant command details include: target identities and any other warrant option (e.g. content of communication interception request indication).
error
This element is used to report error resulting from the execution on the query of the logs.

Instead of using the interfaces HIX1 and HIX2, as an alternative, the interfaces HI1 and HI2 can be used. In this case HI1 will communicate with ADMF (instead of HIX1 communicating with LLAF) and HI2 will communicate with MF/DF2 (instead of HIX2 communicating with LLMF), and the requested logged activity will be fetched from LLECF via an interface between the LI and log Systems. This will be done in a manner obvious to someone skilled in the art.

As an addition to the second embodiment, the supervisor is notified of new interceptions when they are configured in the system in real-time, and not only by queries afterwards. This could be done by “triggers” that are sent to the supervisor for example from MF/DF2 via HI2 or alternatively, for example, via HIX2.

The reciprocal signaling between the above shown different DR and LI entities is to be seen just as example. For example the criteria are in the examples above sent from the RA or LEMF but may also be communicated by an intermediary, such as a human operator who receives the command from an authorized source, and then inputs the criteria.

A system that can be used to put the invention into practice is schematically shown in the FIGS. 3 and 5. Enumerated items are shown in the figures as individual elements. In actual implementations of the invention, however, they may be inseparable components of other electronic devices such as a digital computer. Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The systems and methods of the present invention may be implemented for example on any of the Third Generation Partnership Project (3GPP), European Telecommunications Standards Institute (ETSI), American National Standards Institute (ANSI) or other standard telecommunication network architecture. Other examples are the Institute of Electrical and Electronics Engineers (IEEE) or The Internet Engineering Task Force (IETF).

The description, for purposes of explanation and not limitation, sets forth specific details, such as particular components, electronic circuitry, techniques, etc., in order to provide an understanding of the present invention. But it will be apparent to one skilled in the art that the present invention may be practiced in other embodiments that depart from these specific details. In other instances, detailed descriptions of well-known methods, devices, and techniques, etc., are omitted so as not to obscure the description with unnecessary detail. Individual function blocks are shown in one or more figures. Those skilled in the art will appreciate that functions may be implemented using discrete components or multi-function hardware. Processing functions may be implemented using a programmed microprocessor or general-purpose computer. The invention is not limited to the above described and in the drawings shown embodiments but can be modified within the scope of the enclosed claims.

1. A method for supervising investigator's activities in a Communication Service Provider's domain comprising a monitoring system and a Log System, the method comprising steps of:
sending a request and receiving a result via standard defined interfaces comprising at least two of HIXA, HIXB, HIA, HIB, HIX1, HIX2, HI1, and HI2 connected between a supervising authority and the Provider's domain;
wherein the standard defined interfaces have been enhanced to transfer parameters related to investigator's activities.

2. A method for supervising investigator's activities in a Communication Service Provider's domain according to claim 1 wherein the sending a request and receiving a result via the standard defined interfaces is performed without intervention of a public service/telecom operator.

3. A method for supervising investigator's activities according to claim 1 wherein the standard defined interfaces comprise at least two of HIXA, HIXB, HIX1, and HIX2 connected between a public authority and the Log System.

4. A method for supervising investigator's activities according to claim 1 wherein the standard defined interfaces comprise at least two of HIA, HIB, HI1, and HI2 connected between a public authority and the monitoring system.

5. A method for supervising investigator's activities according to claim 1, wherein the monitoring system is a Data Retention system.

6. A method for supervising investigator's activities according to claim 1, wherein the monitoring system is a Lawful Interception system.

7. A method for supervising investigator's activities according to claim 5 wherein an activity comprises queries from an investigator on retained data information.

8. A method for supervising investigator's activities according to claim 7 wherein the request for investigator's activity comprises at least one of the following demanded parameters:
the time window in which the query has been performed;
the investigator that performed the query;
the country code specified in the query;
the ID of the Authorized Organization specified in the query;
the query reference identifier specified in the query;
the CSP identifier specified in the query;
the third party CSP identifier specified in the query.

9. A method for supervising investigator's activities according to claim 6 wherein an activity comprises warrant administration command information from an investigator.

10. A method for supervising investigator's activities according to claim 9 wherein the request for an activity comprises at least one of the following demanded parameters:
the time window in which a warrant administration command has been ordered;
The user that ordered a warrant administration command;
Identifies of the target of interception specified in a warrant administration command;
Interception options specified in a warrant administration command.

11. A method for supervising investigator's activities according to claim 1, whereby the step of sending a request for investigator's activities is preceded by a trigger that notifies the supervisor of new interceptions.

12. An arrangement for supervising investigator's activities in a Communication Service Provider's domain comprising:
a monitoring system and a Log System, comprising an electronic device for sending a request and receiving a result via standard defined interfaces comprising at least two of HIXA, HIXB, HIA, HIB, HIX1, HIX2, HI1, and HI2 connected between a supervising authority and the Provider's domain,
wherein the interfaces have been enhanced to transfer parameters related to investigator's activities.

13. An arrangement for supervising investigator's activities according to claim 12, wherein the monitoring system is a Data Retention system.

14. An arrangement for supervising investigator's activities according to claim 12, wherein the monitoring system is a Lawful Interception system.

15. An node for supervising investigator's activities in a Communication Service Provider's domain which investigator's activities are received from a monitoring system, wherein the node comprises;
an electronic device for sending a request and receiving a result via standard defined interfaces comprising at least two of HIXA, HIXB, HIA, HIB, HIX1, HIX2, HI1, and HI2 connected between a supervising authority and the Provider's domain,
wherein the interfaces have been enhanced to transfer parameters related to investigator's activities.

16. Article of manufacture comprising:
a program storage medium having a computer readable code embodied therein that, when executed by a computer, is configured to supervise investigator's activities in a Communication Service Provider's domain which investigator's activities are received from a monitoring system, wherein the computer readable code comprises computer readable program code for sending a request and receiving a result via standard defined interfaces comprising at least two of HIXA, HIXB, HIA, HIB, HIX1, HIX2, HI1, and HI2 connected between a supervising authority and the Provider's domain, wherein the interfaces have been enhanced to transfer parameters related to investigator's activities.
